(19) United States
(12) Patent Application Publication
(10) Pub. No.: US 2020/0058232 A1
(43) Pub. Date: Feb. 20, 2020

(54) EDUCATIONAL DOLL SYSTEMS

(71) Applicant: Barnstorming Ventures LLC, Hopkinton, MA (US)

(72) Inventors: Peter A. Thomas, Hopkinton, MA (US); Amy R. Thomas, Hopkinton, MA (US); Charles P. Holden, Hopkinton, MA (US)

(21) Appl. No.: 16/105,551

(22) Filed: Aug. 20, 2018

(51) Int. Cl. G09B 19/00; G09B 23/34

(52) U.S. Cl. CPC G09B 19/0076; G09B 23/34

(57) ABSTRACT

Educational doll systems for teaching female anatomy and use of sanitary products intended for menstruation are provided. The educational doll systems comprise an educational doll comprising an outer shell and internal anatomical features, and apparatus representing sanitary products intended for use when menstruating. The educational doll systems may be used for instruction and for facilitating conversation.

### FIELD OF THE INVENTION

The presently disclosed subject matter relates to an educational doll system, and more particularly, to an educational doll with representations of female anatomy, and representations of sanitary products, useful for teaching teenage and pre-teen girls about how to use sanitary products designed for use when menstruating.

### BACKGROUND OF THE INVENTION

The use of sanitary products designed to maintain sanitary and clean conditions when a person is menstruating is important. Introducing the topic, and educating people, in particular teenage and pre-teen girls, can be awkward, and can be difficult to explain with only conversation or diagrams in a book, or instructions that come with sanitary products. A product that facilitates a conversation about female anatomy and the use of sanitary products such as tampons or absorbent pads can be an aid to any parent or guardian, especially a male parent, and to any health education class or educator, in educating young people about female anatomy and the utility and use of sanitary products intended for use when menstruating. Not every parent—mother or father—is ready or wants to talk to a daughter about her menstrual cycle and its onset. And, with more than half of all marriages ending in divorce, there are many single parents, grandparents, caregivers, and non-traditional families, and many of them do not know how to approach this delicate topic with the girls in their family. A period is every girl and mother's “when is it going to come moment,” and as a result, there is a lot of anxiety around the topic, for young people and their parents and guardians.

The onset of menstruation (“getting a period,” in common usage) is one of the most memorable moments in a girls' teenage life, but cultural taboos keep it shrouded in mystery. Girls often wonder what they will do when it happens, and where they will be. Some girls choose to disengage from specific social activities, like sleepovers, swim parties, and summer camp, for fear of embarrassment.

The current state of the art of educational doll systems related to female anatomy, and the use of sanitary products intended for use when menstruating, presents several problems. While dolls and educational anatomical models are well known, they do not integrate well with health and reproductive health classes. Furthermore, many classes attempt to cover the entire reproductive cycle as well as contraceptive measures, sexually transmitted diseases (STDs) and other risk factors, rather than focusing on menstruation and hygiene, and many of those classes with instructional aids are taught one or two years before the average age of the onset of menstruation, suggesting that many young women may not retain or recall the information from the classes when they need it, and suggesting a need for a teaching tool that is always available to them. Furthermore, existing tools do not provide an accurate representation of female anatomy in combination with accurate representations of sanitary products intended for use when menstruating, or allow demonstrations and practice of the ways to use, insert, and remove such sanitary products while using a realistic educational doll.

### SUMMARY OF THE INVENTION

The present invention meets all these needs, by disclosing systems of an educational doll with representations of female anatomy, and representations of sanitary products. The present invention facilitates education, conversation, and learning about female anatomy, menstruation and the onset of menstruation, and the use of sanitary products for use when menstruating. The present invention further facilitates changing taboos around discussion of menstruation, by presenting an approachable educational doll with accurate depictions of female anatomy.

The present invention allows young women to learn about female anatomy and menstruation in a non-threatening way, so that they are empowered to understand the menstrual cycle and how to approach and use sanitary products. A goal of the present invention is to destroy the stigma that prevents girls and women from having an open and honest conversation about their periods. Periods are a fact of life: no girl should feel shame, anxiety, or brokenness about it. No girl should be unprepared to handle menstruation. The present invention presents a system for learning and education about menstruation and the use of sanitary products related to menstruation, such as tampons and absorbent pads.

The present invention also reduces the risk of physical injury to young women, because if sanitary products are not used as indicated, they can lead to injury or infection. Appropriate education and instruction in their use can lower the risk of injury, and the present invention facilitates such education and instruction.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows a front perspective view of an educational doll with organs visible.

FIG. 2 shows a front elevation view of an educational doll with organs visible.

FIG. 3 shows a front perspective view of the torso of an educational doll with organs visible.

FIG. 4 shows a bottom perspective view of the torso of an educational doll.

FIG. 5 shows an exploded side perspective view of selected components of the torso assembly of an educational doll.

FIG. 6 shows a rear elevation view of the front cavity insert of the present invention.

FIG. 7 shows a front elevation view of rear cavity insert of the present invention.

FIG. 8 shows an exploded side elevation view of the torso assembly of an educational doll of the present invention.

FIG. 9A shows a front elevation view of the reproduction system insert of an educational doll of the present invention.

FIG. 9B shows a front elevation view of the reproduction system insert, without the vaginal canal front piece, of an educational doll of the present invention.

FIG. 10 shows an exploded side elevation view of an exemplary tampon, applicator, and plunger assembly of the present invention.

FIG. 11A shows an exploded perspective view of an exemplary tampon, applicator, and plunger assembly of the present invention.

FIG. 11B shows an assembled perspective view of an exemplary tampon, applicator, and plunger assembly of the present invention.

FIG. 12A shows a schematic elevation view of insertion of tampon into the vaginal canal of the exemplary education doll.

FIG. 12B shows a schematic elevation view of an exemplary tampon inserted into the vaginal canal of the exemplary education doll, with the applicator removed.

FIG. 13A shows a perspective view of part of the torso of an exemplary educational doll, with an exemplary applicator assembly inserted with the plunger extended.

FIG. 13B shows a perspective view of part of the torso of an exemplary educational doll, with an exemplary applicator assembly inserted with the plunger inserted.

FIG. 13C shows a perspective view of part of the torso of an exemplary educational doll, with an exemplary applicator assembly removed.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the methods and systems of the present invention.

The present subject matter discloses embodiments of educational doll systems with representations of female anatomy, and representations of sanitary products. At a high level of overview, the educational dolls of the present invention are made so that elements of anatomy and visible and the user can interact with them, and the representations of sanitary products allow users to learn about and practice using the representations of sanitary products in their intended fashion with the elements of anatomy of the educational dolls.

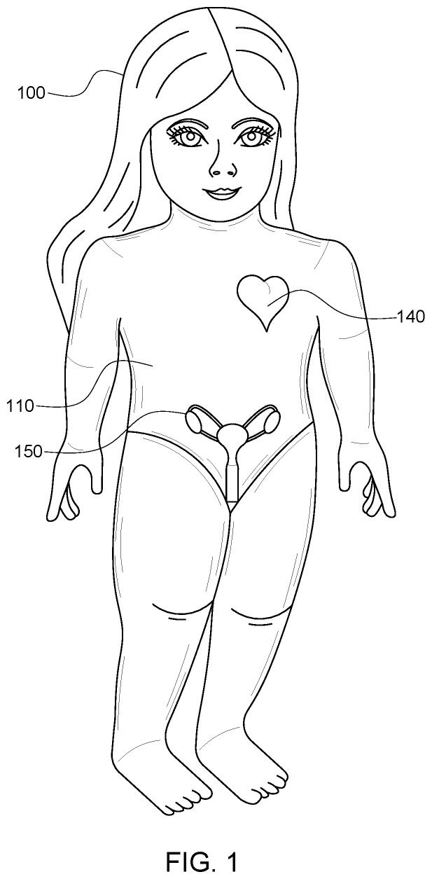

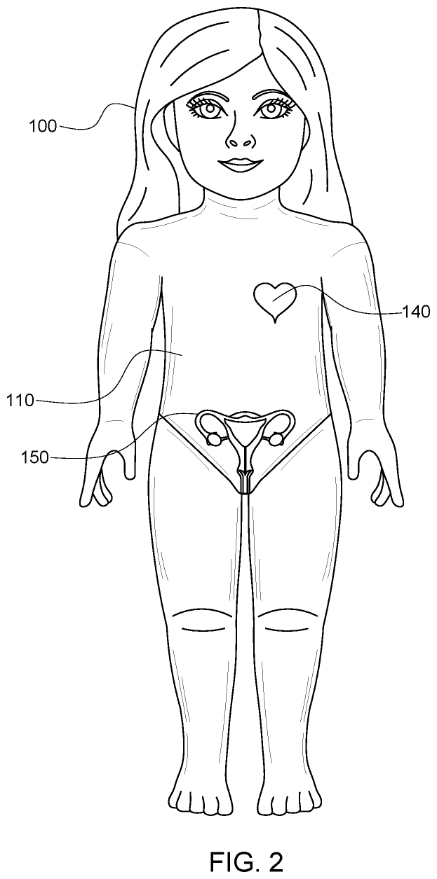

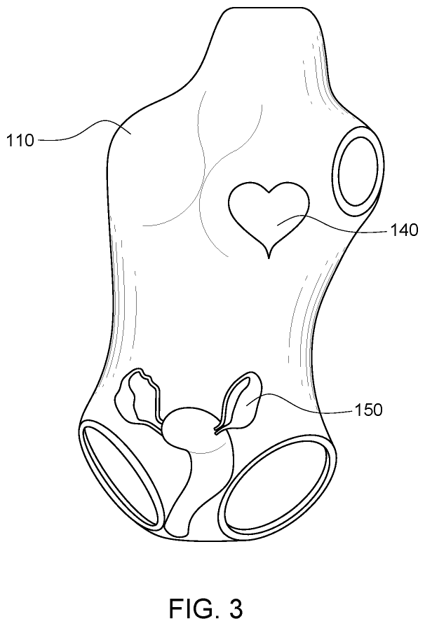

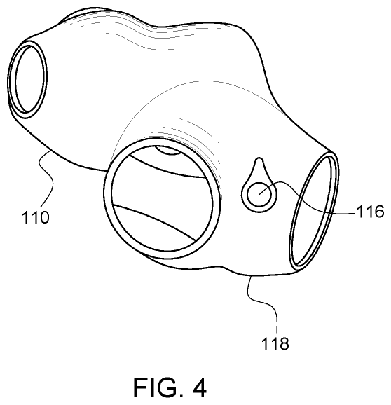

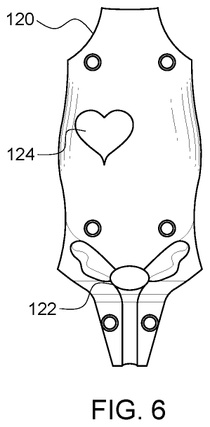

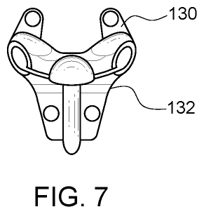

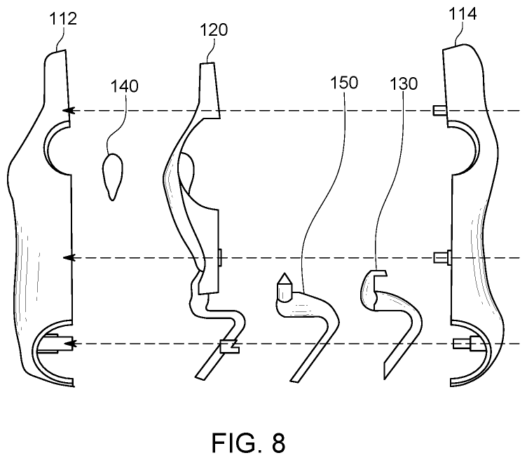

FIG. 1 and FIG. 2 illustrate the educational dolls 100 of the present invention, presenting a doll 100 comprising a torso 110, which torso 110 comprises a heart 140 and a reproduction system insert 150. The doll 100 may have any of a range of appearances typical of teenage or pre-teen girls. FIGS. 3, 4, 5, 6, 7, and 8 present views of the torso 110 and its assembly. The torso 110 further comprises a torso vaginal opening 116 and a torso anal opening 118, which are visible on the underside of the torso 110, and the torso vaginal opening 116 is disposed in the torso 110 to line up with the reproduction system insert 150 which is disposed inside the torso 110. The torso 110 may further comprise a torso front piece 112, a torso back piece 114, a front cavity insert 120, and a rear cavity insert 130, which are formed, it has been found advantageous, from a transparent material, so that the inner anatomy of the educational doll 100—in particular, the reproduction system insert 150—may be visible. The torso front piece 112 and the torso back piece 114 together comprise an exterior shell of the torso 110. The front cavity insert 120 may comprise a front cavity heart molding 124, which is a locus for containing the heart 140 between the front cavity insert 120 and the torso front piece 112. The front cavity insert 120 connects to the torso front piece 112. The front cavity insert 120 may comprise front cavity reproduction moldings 122, which are a locus for containing the reproduction system insert 150, which reproduction system insert 150 is surrounded at its rear sides by the rear cavity insert 130, in a rear cavity reproduction moldings 132, which are a locus for containing the reproduction system insert 150. The rear cavity insert 130 fits with the front cavity insert 120 to contain the reproduction system insert 150. The rear cavity insert 130 and the front cavity insert 120 connect with the torso back piece 114, as shown in FIG. 8, to secure the assembly of the torso 110 and the internal organs (the reproduction system insert 150 and the heart 140).

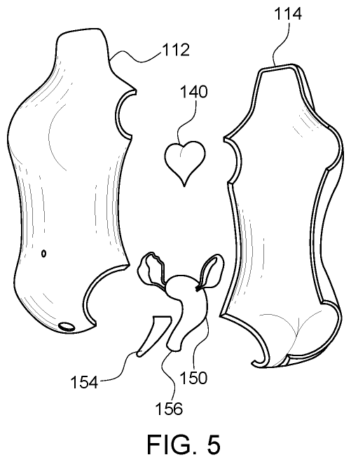

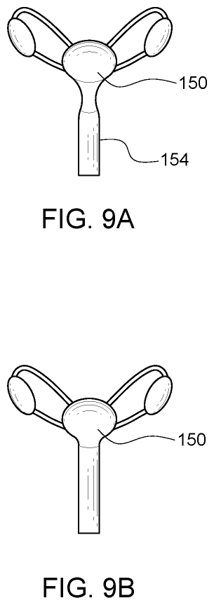

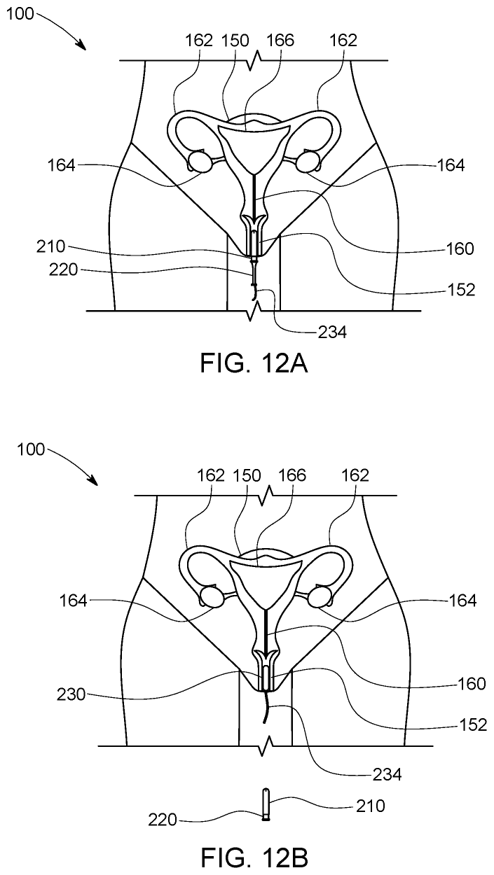

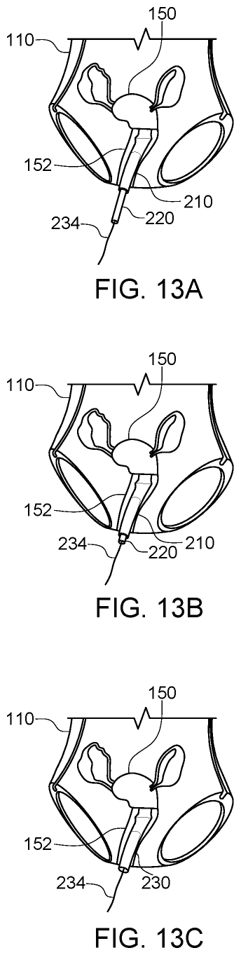

With reference to FIG. 5, FIG. 9A, FIG. 9B, FIG. 12A, FIG. 12B, FIG. 13A,

FIG. 13B, and FIG. 13C, the reproduction system insert 150 further comprises a vaginal canal 152, a vaginal canal front piece 154, a vaginal canal rear section 156, a cervix 160, a plurality of fallopian tubes 162, a plurality of ovaries 164, and a uterus 166. The vaginal canal 152 is formed from the vaginal canal front piece 154 and the vaginal canal rear section 156, which connect to each other; the vaginal canal front piece 154 may be reversibly removed from and re-attached to the vaginal canal rear section 156. As discussed above, the vaginal canal 152 of the reproduction system insert 150 is positioned inside the torso 110 to align with the torso vaginal opening 116 of the torso 110, to provide a realistic educational representation of the opening of a vagina between the labia, and the interior of a vagina.

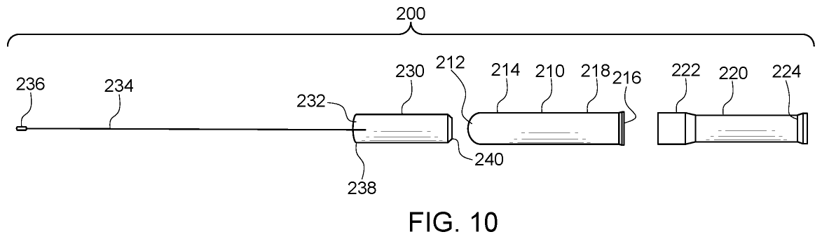

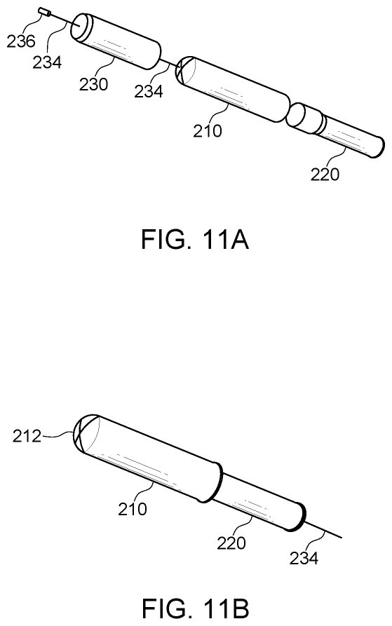

With reference to FIG. 10, FIG. 11A, FIG. 11B, FIG. 12A, FIG. 12B, FIG. 13A, FIG. 13B, and FIG. 13C, the educational doll 100 system of the present invention further comprises a tampon assembly 200, which a user of the educational doll 100 may use to learn about how to insert a tampon. The tampon assembly 200 comprises a tampon applicator 210, a plunger 220, and a tampon 230. The tampon applicator 210 comprises an approximately cylindrical tube of material having an inner diameter and an outer diameter, which material is rigid or approximately rigid, comprising an applicator proximal end 214, an applicator distal end 216, and an applicator grip indicator 218, with the applicator proximal end 214 being mostly closed but with a plurality of applicator slits 212 in the applicator proximal end 214, which applicator proximal end 214 is made of flexible and elastic material so that the plurality of applicator slits 212 allow the material of the applicator proximal end 214 to flex open and return to an approximately closed position. The applicator distal end 216 is approximately open, and not closed off.

The plunger 220 comprises an approximately cylindrical tube of material that is rigid or approximately rigid, and the outer diameter of the plunger 220 fits snugly into the inner diameter of the tampon applicator 210. The plunger 220 further comprises a plunger proximal end 222 and a plunger distal end 224; the plunger proximal end 222 is to be inserted into the tampon applicator 210 first, such that the plunger proximal end 222 moves from the applicator distal end 216 to the applicator proximal end 214. It has been found advantageous to have the plunger 220 be approximately the same length as the tampon applicator 210, or be slightly longer, so that the plunger 220 may be fully inserted into the tampon applicator 210 and still have the plunger distal end 224 grasped and removed from the tampon applicator 210.

The tampon 230 comprises a tampon axial hole 232 having an outer diameter inside the tampon 230, through which tampon axial hole 232 a tampon string 234 is passed. The tampon 230 further comprises a tampon proximal end 238 and a tampon distal end 240. The tampon string 234 is secured in the tampon 230 with a tampon string retainer bead 236 having an outer diameter, which tampon string retainer bead 236 is fixed to the tampon string 234 and which tampon string retainer bead 236 has a larger outer diameter than the outer diameter of the tampon axial hole 232. The tampon string 234 passes from the tampon proximal end 238 through the tampon axial hole 232 and through the tampon distal end 240. It has been found advantageous to have the tampon 230 be shorter than the tampon applicator 210, so that the plunger 220 may be inserted in and push the tampon 230. The tampon 230 may, it has been found advantageous, comprise an elastic material; in some embodiments, the elastic material of the tampon 230 is advantageously a material that is easily compressed slightly, and which expands when not compressed, preferably to its non-compressed volume, including but not limited to a polyurethane foam.

To assemble the tampon assembly 200, a user inserts the tampon 230 into the tampon applicator 210, inserting the tampon proximal end 238 first and pushing the tampon 230 in until the tampon proximal end 238 approximately matches up with the applicator proximal end 214. The user then inserts the plunger proximal end 222 into the open applicator distal end 216, so that the plunger proximal end 222 contacts the tampon distal end 240, and the plunger distal end 224 is outside of and distal to the applicator distal end 216. It has been found advantageous to have the user ensure that the tampon string 234 remains accessible and sticking out of the tampon applicator 210 at the applicator distal end 216. To use the tampon applicator 210 to insert the tampon 230 into the vaginal canal 152 and remove the tampon applicator 210, leaving the tampon 230 in the vaginal canal 152, the user may insert the tampon assembly 200 through the torso vaginal opening 116 into the vaginal canal 152, and then may press the plunger 220 into the tampon applicator 210 until the plunger proximal end 222 is approximately at the applicator proximal end 214, pushing the tampon 230 through the applicator slits 212 and into the vaginal canal 152. The user may then withdraw the tampon assembly, then comprising only the tampon applicator 210 and the plunger 220, from the vaginal canal 152, leaving the tampon 230 in the vaginal canal 152. The tampon 230 may later be removed from the vaginal canal 152 by pulling on the tampon string 234. The process described herein may be repeated with the components of the present invention reused. Because the tampon 230 comprises a compressible and expandable material, as described above, the tampon 230 may be slightly compressed when inserted into the tampon applicator 210, and when the tampon 230 is pushed out of the tampon applicator 210, the tampon 230 expands slightly in the vaginal canal 152, so that the tampon 230 remains in place in the vaginal canal 152. Later, when the tampon 230 is removed from the vaginal canal 152, the tampon 230 may be compressed into the tampon applicator 210.

Certain embodiments of the present invention were described above.

From the foregoing it will be seen that this invention is one well adapted to attain all the ends and objects set forth above, together with other advantages, which are obvious and inherent to the system and method of the present invention. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. An educational doll system with representations of female anatomy and representations of sanitary products, for users to learn about and practice using the representations of sanitary products, the educational doll system comprising:
a torso, which torso comprises:
a torso front piece and a torso back piece, which together comprise an exterior shell of the torso;
a front cavity insert and a rear cavity insert;
a heart, a reproduction system insert, a torso vaginal opening, and a torso anal opening, wherein the torso vaginal opening is disposed in the torso to line up with the reproduction system insert, and wherein the reproduction system insert comprises a vaginal canal; and
a tampon assembly comprising a tampon applicator, a plunger, and a tampon; in which the tampon applicator comprises an approximately cylindrical tube of material having an inner diameter and an outer diameter, and in which the plunger comprises an approximately cylindrical tube of material, having an outer diameter, that is rigid or approximately rigid, and in which the plunger is approximately the same length as the tampon applicator;
and wherein the tampon assembly may inserted through the torso vaginal opening into the vaginal canal.

2. The educational doll system of claim 1, in which the torso and the front cavity insert and the rear cavity insert are formed from a transparent material.

3. The educational doll system of claim 1, in which the front cavity insert comprises a front cavity heart molding and front cavity reproduction moldings, and the rear cavity insert comprises rear cavity reproduction moldings.

4. The educational doll system of claim 1, in which the reproduction system insert comprises a vaginal canal front piece, a vaginal canal rear section, a cervix, a plurality of fallopian tubes, a plurality of ovaries, and a uterus; and in which reproduction system insert the vaginal canal is formed from the vaginal canal front piece and the vaginal canal rear section.

5. The educational doll system of claim 1, in which the tampon applicator comprises an applicator proximal end, an applicator distal end, and an applicator grip indicator, with the applicator proximal end comprising a plurality of applicator slits, and which applicator proximal end is flexible and elastic; and in which the applicator distal end is approximately open.

6. The educational doll system of claim 1, in which the outer diameter of the plunger fits snugly into the inner diameter of the tampon applicator, and the plunger further comprises a plunger proximal end and a plunger distal end.

7. The educational doll system of claim 1, in which the tampon comprises a tampon axial hole having an outer diameter inside the tampon, through which tampon axial hole a tampon string is passed, and which tampon string is secured in the tampon with a tampon string retainer bead having an outer diameter, which tampon string retainer bead is fixed to the tampon string and which tampon string retainer bead has a larger outer diameter than the outer diameter of the tampon axial hole; and which tampon further comprises a tampon proximal end and a tampon distal end, wherein the tampon string passes from the tampon proximal end through the tampon axial hole and through the tampon distal end.

8. The educational doll system of claim 1, in which the tampon is shorter than the tampon applicator, and in which the tampon comprises an elastic material.

9. The educational doll system of claim 1, in which the tampon assembly is assembled by the tampon being inserted into the tampon applicator, then the plunger being inserted into the open applicator distal end, wherein the tampon string remains accessible and sticking out of the tampon applicator, and the tampon assembly being inserted through the torso vaginal opening into the vaginal canal.

10. An educational doll system with representations of female anatomy and representations of sanitary products, for users to learn about and practice using the representations of sanitary products, the educational doll system comprising:
a torso, which torso comprises a torso front piece and a torso back piece, which together comprise an exterior shell of the torso; a heart; a reproduction system insert; a torso vaginal opening; and a torso anal opening; wherein the torso vaginal opening is disposed in the torso to line up with the reproduction system insert, and wherein the reproduction system insert comprises a vaginal canal; and
a tampon assembly comprising a tampon applicator which comprises an approximately cylindrical tube of material having an inner diameter and an outer diameter; and a plunger having an outer diameter; and a tampon which tampon is shorter than the tampon applicator, and which tampon comprises an elastic material;
and wherein the tampon assembly may inserted through the torso vaginal opening into the vaginal canal.

11. The educational doll system of claim 10, in which the torso further comprises a front cavity insert and a rear cavity insert.

12. The educational doll system of claim 11, in which the torso and the front cavity insert and the rear cavity insert are formed from a transparent material.

13. The educational doll system of claim 11, in which the front cavity insert comprises a front cavity heart molding and front cavity reproduction moldings, and the rear cavity insert comprises rear cavity reproduction moldings.

14. The educational doll system of claim 10, in which the reproduction system insert comprises a vaginal canal front piece, a vaginal canal rear section, a cervix, a plurality of fallopian tubes, a plurality of ovaries, and a uterus; and in which reproduction system insert the vaginal canal is formed from the vaginal canal front piece and the vaginal canal rear section.

15. The educational doll system of claim 10, in which the tampon applicator comprises an applicator proximal end, an applicator distal end, and an applicator grip indicator, with the applicator proximal end comprising a plurality of applicator slits, and which applicator proximal end is flexible and elastic.

16. The educational doll system of claim 10, in which the plunger comprises an approximately cylindrical tube of material that is rigid or approximately rigid, and the outer diameter of the plunger fits snugly into the inner diameter of the tampon applicator, and the plunger further comprises a plunger proximal end and a plunger distal end.

17. The educational doll system of claim 10, in which the tampon comprises a tampon axial hole having an outer diameter inside the tampon, through which tampon axial hole a tampon string is passed, and which tampon string is secured in the tampon with a tampon string retainer bead having an outer diameter, which tampon string retainer bead is fixed to the tampon string and which tampon string retainer bead has a larger outer diameter than the outer diameter of the tampon axial hole; and which tampon further comprises a tampon proximal end and a tampon distal end, wherein the tampon string passes from the tampon proximal end through the tampon axial hole and through the tampon distal end.

18. The educational doll system of claim 10, in which the tampon assembly is assembled by the tampon being inserted into the tampon applicator, then the plunger being inserted into the open applicator distal end, wherein the tampon string remains accessible and sticking out of the tampon applicator, and the tampon assembly being inserted through the torso vaginal opening into the vaginal canal.

19. The educational doll system of claim 18, in which the tampon assembly is used to insert the tampon into the vaginal canal and remove the tampon applicator, leaving the tampon in the vaginal canal, by the plunger being pressed into the tampon applicator, pushing the tampon through the applicator slits and into the vaginal canal.

20. An educational doll system with representations of female anatomy and representations of sanitary products, the educational doll system comprising:
a torso, which torso comprises an exterior shell of the torso which is formed from a transparent material; a reproduction system insert; and a torso vaginal opening; wherein the torso vaginal opening is disposed in the torso to line up with the reproduction system insert, and wherein the reproduction system insert comprises a vaginal canal; and
a tampon assembly comprising a tampon applicator which comprises an approximately cylindrical tube of material having an inner diameter and an outer diameter; and a plunger having an outer diameter; and a tampon which tampon is shorter than the tampon applicator, and which tampon comprises an elastic material and a tampon string;
and wherein the tampon assembly may inserted through the torso vaginal opening into the vaginal canal;
and wherein the tampon may be inserted into the vaginal canal and the tampon applicator removed, wherein the tampon remains in place in the vaginal canal.
